(19) United States
(12) Patent Application Publication
(10) Pub. No.: US 2016/0148101 A1
(43) Pub. Date: May 26, 2016

(54) KNOWLEDGE EVALUATION APPARATUS, METHOD, AND SYSTEM

(71) Applicant: Electronics and Telecommunications Research Institute, Daejeon (KR)

(72) Inventors: Young Jik LEE, Daejeon (KR); Hyun Ki KIM, Daejeon (KR); Hyo Jung OH, Daejeon (KR)

(21) Appl. No.: 14/932,471

(22) Filed: Nov. 4, 2015

(30) Foreign Application Priority Data
Nov. 21, 2014 (KR) 10-2014-0163224

(51) Int. Cl. G06N 5/04; G06N 99/00

(52) U.S. Cl. CPC G06N 5/04; G06N 99/005

(57) ABSTRACT

A knowledge evaluation apparatus, method, and system are provided. The knowledge evaluation apparatus includes an extraction module configured to extract at least one of triple information which is previously set with respect to a document for each field accumulated in an Internet community site; a classification module configured to classify and digitize the triple information extracted from the document for each field by a topic and an item; and a measurement module configured to measure knowledge maturity of the Internet community site based on the knowledge classified and digitized by the classification module.

### CROSS-REFERENCE TO RELATED APPLICATION

This application claims priority to and the benefit of Korean Patent Application No. 10-2014-0163224, filed on Nov. 21, 2014, the disclosure of which is incorporated herein by reference in its entirety.

### BACKGROUND

1. Field of the Invention

The present invention relates to knowledge processing technology, and more particularly, to a knowledge evaluation apparatus, method, and system capable of evaluating knowledge in an Internet community site.

2. Discussion of Related Art

The World Wide Web developed in 1990s was developed as a Blog or an Internet community site, etc. in 2000s.

Particularly, the Web 2.0 in which a user of information voluntarily contributes to generate information activated more this movement. As a result, a lot of Internet communities are generated and actively used, and the Internet community is composed of thousands to hundred millions of members.

A group accumulating knowledge based on document (document data) construction like the Internet community site is referred to as a knowledge group. Most of knowledge groups (the Internet community sites such as a Google+ community, a Naver café, a Daum café, etc.) accumulate knowledge in a manner in which the members voluntarily upload document. Accordingly, when a range of information covered by the accumulated document is great, the range of the information is being classified by collecting a majority opinion of the knowledge group. For example, a person uploading a document voluntarily determines whether his/her document belongs to any classification, and discloses the document in a corresponding folder.

The knowledge group is formed in a main portal site, and the main portal site assigns a grade such as a development level (for example, levels 1 to 5, etc.) to each café by evaluating the number of members, or the number of documents and the number of comments added for each unit period with respect to each knowledge group.

Such a development level becomes a motivation factor for members of a corresponding knowledge group, and can be utilized to estimate whether there is a certain degree of faithful information in a corresponding knowledge group for a general person.

However, the number of knowledge groups or the number of documents added for each unit period used for evaluating the development level is positively related to knowledge maturity of the knowledge group, but is not directly related to an amount and a quality of knowledge possessed by the knowledge group.

Further, there is a case in which any member makes an effort for a work which is not related to improvement of the knowledge maturity, such as daily attendance (login) of members or shiritori, etc. in order to increase the development level of the knowledge group to which he/she belongs, and thus a relation between the development level and the amount and quality of the knowledge in the knowledge group is decreased more.

Moreover, it is not possible to know how to increase the knowledge maturity in the knowledge group, using only information related to the development level.

### SUMMARY OF THE INVENTION

The present invention is directed to a knowledge evaluation apparatus, method, and system capable of evaluating knowledge maturity of an Internet community site.

The present invention is not limited to the object described above, and other objects which are not described will become more apparent to those of ordinary skill in the art by the following description.

According to one aspect of the present invention, there is provided a knowledge evaluation apparatus, including: an extraction module configured to extract at least one of triple information which is previously set with respect to a document for each field accumulated in an Internet community site; a classification module configured to classify and digitize the triple information extracted from the document for each field by a topic and an item; and a measurement module configured to measure knowledge maturity of the Internet community site based on the knowledge classified and digitized by the classification module.

The extraction module may classify the document for each field based on the field which is previously set by a manager in the Internet community site, and extract the triple information with respect to the document for each field.

The classification module may classify the triple information by each topic according to a first entity name which is previously set, and classify and digitize the triple information classified by each topic by an item which is previously set.

The measurement module may confirm whether there is a knowledge gap among each topic and items in each topic in the classified knowledge, and inform a member in the Internet community site.

The measurement module may confirm a knowledge difference among items in each topic in the classified knowledge, and inform a member in the Internet community site.

When it is confirmed that the knowledge difference is an error by a feedback of the member, the measurement module or another component may delete a document corresponding to the knowledge difference.

When it is confirmed that the knowledge difference is content needed to be subdivided, the classification module may subdivide the triple information corresponding to the knowledge difference into a plurality of topics or items.

The measurement module may receive solutions from a plurality of members confirming the knowledge difference, and solve the knowledge difference.

The extraction module may extract the triple information with respect to the document for each field in each period which is previously set or when updating the document for each field.

According to another aspect of the present invention, there is provided to a knowledge evaluation method, including: extracting at least one of triple information which is previously set with respect to a document for each field accumulated in an Internet community site; classifying and digitizing the triple information extracted from the document for each field by a topic and an item; and measuring knowledge maturity of the Internet community site based on the knowledge classified and digitized in the classifying and digitizing of the triple information.

The extracting of at least one of the triple information may include: classifying the document for each field based on the field which is previously set by a manager in the Internet community site; and extracting the triple information with respect to the document for each field.

The classifying and digitizing of the triple information may include: classifying the triple information by each topic according to a first entity name which is previously set; and classifying and digitizing the triple information classified by each topic by an item which is previously set.

The measuring of the knowledge maturity may include: confirming whether there is a knowledge gap among each topic and items in each topic in the classified knowledge, and informing a member in the Internet community site.

The measuring of the knowledge maturity may include: confirming the knowledge difference among items in each topic in the classified knowledge, and informing a member in the Internet community site.

When it is confirmed that the knowledge difference is an error by a feedback of the member, the knowledge evaluation method may further include: after the measuring of the knowledge maturity, deleting a document corresponding to the knowledge difference.

When it is confirmed that the knowledge difference is content needed to be subdivided, the knowledge evaluation method may further include: after the measuring of the knowledge maturity, subdividing the triple information corresponding to the knowledge difference into a plurality of topics or items.

The measuring of the knowledge maturity may include: receiving solutions from a plurality of members confirming the knowledge difference, and solving the knowledge difference.

The extracting of the triple information may extract the triple information with respect to the document for each field by a previously set period.

According to still another aspect of the present invention, there is provided to a knowledge evaluation system, including: a database configured to store a document for each field accumulated in an Internet community site; and a knowledge evaluation apparatus configured to extract at least one of triple information which is previously set with respect to the document for each field, classify and digitize the triple information by a topic and an item, and measure knowledge maturity of the Internet community site.

The knowledge evaluation apparatus may extract the triple information with respect to the document for each field in a period which is previously set or when updating the document for each field.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating a knowledge evaluation system according to an embodiment of the present invention;

FIG. 2 is a diagram illustrating a knowledge evaluation apparatus according to an embodiment of the present invention;

FIG. 3 is a conceptual diagram for describing knowledge evaluation of a knowledge evaluation apparatus according to an embodiment of the present invention;

FIG. 4 is a graph illustrating a knowledge classification result according to an embodiment of the present invention; and

FIG. 5 is a flowchart for describing a knowledge evaluation method according to an embodiment of the present invention.

### DETAILED DESCRIPTION OF EXEMPLARY EMBODIMENTS

The above and other objects, features, and advantages of the present invention will become more apparent by describing in detail exemplary embodiments thereof with reference to the accompanying drawings. However, the present invention is not limited to exemplary embodiments which will be described hereinafter, and can be implemented by various different types. Exemplary embodiments of the present invention are described below in sufficient detail to enable those of ordinary skill in the art to embody and practice the present invention. The present invention is defined by claims. Meanwhile, the terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

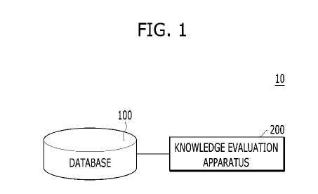

FIG. 1 is a diagram illustrating a knowledge evaluation system according to an embodiment of the present invention.

As shown in FIG. 1, the knowledge evaluation system according to an embodiment of the present invention may include a database 100, and a knowledge evaluation apparatus 200.

The database 100 may store a document for each field accumulated in a knowledge group. Here, the knowledge group may be an Internet community site such as a Google+ community, a café, a blog, etc. of each portal site. Each field in the knowledge group may be a menu of a bulletin board which is previously classified by a manager or an operator, etc. of the knowledge group. Further, in the database 100 including the document (document data) in the knowledge group, each field in the knowledge group may be classified by each folder.

Hereinafter, the knowledge group and the Internet community site, and the document and the document data may be interchangeably used, respectively.

The knowledge evaluation apparatus 200 may extract at least one of triple information which is previously set for the document for each field in the knowledge group, and evaluate knowledge maturity of the knowledge group by digitizing after classifying the triple information for each topic and each item. Here, the triple information may be the most general information extraction form, and express the knowledge information in a sentence as a relation of subject, predicate, and object. For example, the triple information may be the subject: a subject form, the predicate, the object: an object form, and the subject form and the object form may be an entity name form of the subject and the object. For example, when the entity name is Hong Gil Dong, the entity name form may be a person's name, and when the entity name is a worker, the entity name form may be a job.

Further, the knowledge evaluation apparatus 200 may confirm a knowledge gap or a knowledge difference of the knowledge group, inform the member in the knowledge group, and obtain a solution from the member.

In this case, the knowledge evaluation apparatus 200 may present the knowledge maturity to the portal site, and provide objective reliability of the knowledge group. Accordingly, an embodiment according to the present invention may provide an evaluation reference of the knowledge maturity which is advanced compared with a conventional café development level.

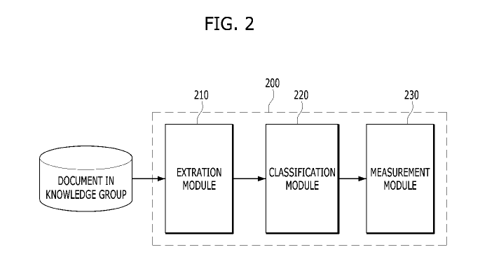

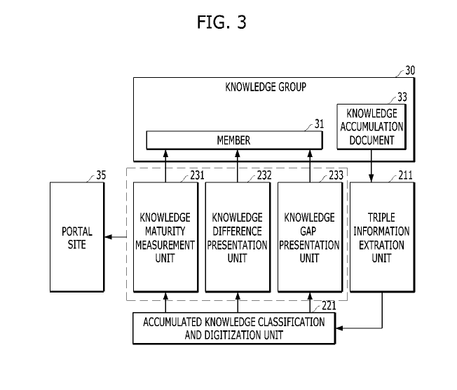

FIG. 2 is a diagram illustrating a knowledge evaluation apparatus according to an embodiment of the present invention, and FIG. 3 is a conceptual diagram for describing knowledge evaluation of a knowledge evaluation apparatus according to an embodiment of the present invention.

As shown in FIG. 2, the knowledge evaluation apparatus 200 according to an embodiment of the present invention may include an extraction module 210, a classification module 220, and a measurement module 230. The knowledge evaluation apparatus 200 may be included in an apparatus configuring the knowledge group, and be configured to be separated from the apparatus configuring the knowledge group.

The extraction module 210 may extract at least one of triple information which is previously set for the document for each field accumulated in the knowledge group.

In this case, the extraction module 210 may classify the document in the knowledge group by each field using a field set by a manager (or an operator, etc.) in the knowledge group, confirm the document accumulated in each field, and extract the triple information by analyzing a sentence in each document. For example, there may be fields such as seeding, harvesting, pest control, fertilizing, etc. in the knowledge group with respect to a vegetable garden.

The extraction module 210 may extract the triple information from the document for each field by a previously set period (for example, one week). Alternatively, the extraction module 210 may extract the triple information whenever the document for each field is updated.

The classification module 220 may classify the triple information extracted from the document for each field by the topic and the item. In detail, the classification module 220 may classify the triple information by each topic corresponding to a first entity name which is previously set, and classify the triple information classified by the topic by a sub-item which is previously set.

For example, when the knowledge group is a community formed by people having an interest in an “organic food,” the field of a corresponding community may be harvesting, pest control, cooking, etc. In this case, each vegetable name which is the first entity name of the “harvesting” field is the topic of each field, and its sub-item may be a harvesting period (when), a harvesting place (where), a seeding transplantation (what), a harvesting method (how), or a hobby (why), etc.

The classification module 220 described above may classify every first entity name confirmed from the extracted triple information as a different topic, respectively.

The measurement module 230 may perform at least one among a knowledge maturity measurement, a knowledge gap presentation, and a knowledge difference portion presentation, for the knowledge group based on the classified knowledge.

First, when describing the knowledge maturity measurement, the measurement module 230 may calculate a degree in which an item for each topic of knowledge which is classified is filled as a percentage, and measure the knowledge maturity of a corresponding knowledge group by calculating an average or an average of weight values of the calculated percentages. In this case, when there is at least one sub-item in each topic, the corresponding item may be evaluated to be filled. Further, when every sub-item of each topic is filled, the measurement module 230 may confirm that the corresponding topic is completed.

For example, when the “harvesting” field in the knowledge group having an interest in the “organic food” is filled by 90%, the “pest control” field is filled by 50%, and the “cooking” field is filled by 10%, the knowledge maturity of the corresponding knowledge group may be

$$50 ( = \frac{90 + 50 + 10}{3} )$$

points which are an average of each field. Alternatively, when weight values of the “harvesting,” “pest control,” and “cooking” fields in the corresponding knowledge group are 0.6, 0.3, and 0.1, respectively, the knowledge maturity of the corresponding knowledge group may be 70 (=0.6×90+0.3×50+0.1×10) points which are an average of the weight values of each field.

The measurement module 230 may present the measured knowledge maturity to a portal site. Accordingly, an embodiment of the present invention may provide a basis capable of allowing the members inside or outside each portal site to determine the knowledge maturity between knowledge groups more objectively.

Further, the measurement module 230 may confirm whether there is a knowledge gap or a knowledge difference among each topic and the items in each topic in the classified knowledge, and inform the member in the knowledge group. Here, the measurement module 230 may inform the member in the knowledge group of the knowledge gap or the knowledge difference, and inform some of the members such as an operator, etc. of the knowledge gap or the knowledge difference.

In this case, the member in the knowledge group confirming the knowledge gap may upload the document for filling the knowledge gap in order to compensate information needed in the knowledge group. Accordingly, the knowledge maturity of the knowledge group to which he/she belongs may be improved.

Further, the member in the knowledge group confirming the knowledge difference may confirm whether the knowledge difference corresponds to an error or content in which a subdivision is needed, and request an error correction or a subdivision.

Then, the measurement module 230 or another component may delete the document confirmed as the error, or correct the error of the corresponding document according to a feedback of the member in the knowledge group. Further, the measurement module 230 or another component may subdivide the triple information corresponding to the knowledge difference into a plurality of topics or items according to the feedback of the member in the knowledge group.

As one example, when a total of three triple information is extracted with respect to a “period of planting codonopsis lanceolata” and the periods are “early April,” “Autumn,” and “early November” respectively, the measurement module 230 may determine that there is the knowledge difference in the corresponding triple information, inform the member in the knowledge group, and request a solution. After this, when an answer indicating that one of three pieces of the triple information is incorrect is received from at least one member, the measurement module 230 may remove the knowledge difference by deleting incorrect triple information and the document from which the incorrect triple information is extracted.

As another example, when different triple information is extracted with respect to a “period of planting a potato” and the periods are “late March” and “late May” respectively, the measurement module 230 may inform the member in the knowledge group of the knowledge difference. After this, the measurement module 230 may receive a feedback in which the planting is performed “in Chungcheong in late March” and the planting is performed “in Hongcheon in late May” from the member. In this case, the measurement module 230 may perform the knowledge subdivision of subdividing the item “where” of the topic “potato” through the classification module 220.

The measurement module 230 described above may receive answers of a plurality of members in order to increase accuracy of the solution with respect to the knowledge difference, and remove the knowledge difference.

When summarizing with reference to FIG. 3, there may be at least one member 31 in one knowledge group 30, and there may be at least one knowledge accumulation document 33 accumulated by the member 31. However, in an embodiment of the present invention, the extraction module 210 may extract the triple information from the sentence in the knowledge accumulation document 33 for each field through a triple information extraction unit 211, the classification module 220 may classify and digitize the knowledge accumulated through a knowledge classification and digitization unit 221, and the measurement module 230 may measure the knowledge maturity with respect to the knowledge accumulation document 33 through a knowledge maturity measurement unit 231, inform a portal site 35 and the member 31, confirm the knowledge difference or the knowledge gap in the knowledge accumulation document 33, present whether there is the knowledge difference or the knowledge gap to the member 31 through a knowledge difference presentation unit 232 and a knowledge gap presentation unit 233, and thus remove the knowledge difference or the knowledge gap.

An embodiment of the present invention may refer to the triple information with respect to the document for a portion or all of fields in the knowledge group, and measure the knowledge maturity in an objective manner compared with the conventional art.

Further, an embodiment of the present invention may present whether it is good to compensate the knowledge of any portion in order to increase the knowledge maturity of the knowledge group, and allow the member to correct an error or subdivide the item by informing the member of the knowledge of being different. Accordingly, an embodiment of the present invention may allow the knowledge group to accumulate the knowledge effectively, and allow an ordinary person to find the knowledge group having high reliability.

Moreover, an embodiment of the present invention may motivate the knowledge groups to increase the knowledge maturities of various Internet communities and induce active knowledge accumulation activities in the knowledge groups by disclosing the knowledge maturities with respect to various knowledge groups in the portal site, and provide a driving force for securing competitiveness of a search market and an advertising market to each portal operator.

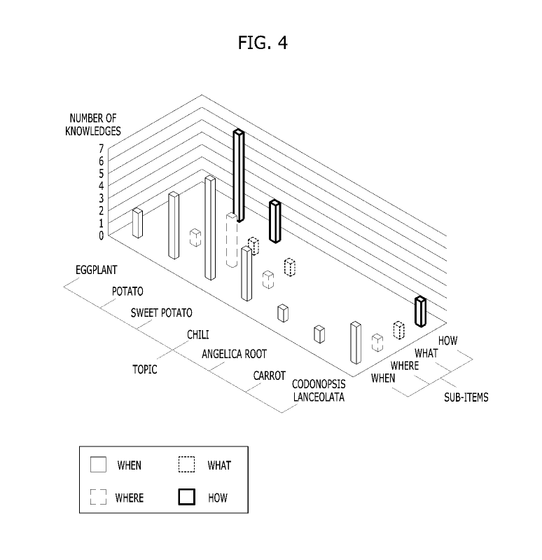

Hereinafter, a knowledge classification operation according to an embodiment of the present invention will be described with reference to FIG. 4. FIG. 4 is a graph illustrating a knowledge classification result according to an embodiment of the present invention.

The extraction module 210 may analyze the sentence of the document for the field “seeding” in the knowledge group related to the “vegetable garden,” and extract the triple information.

The classification module 220 may classify and illustrate a seeding period (when), a seeding transplantation (or, whether the seeding is performed) (what), a planting place (where), and a planting method (how), for each vegetable.

As shown in FIG. 4, the number of topics which is extracted from the document for each field is 7, a total of 6 documents are written with respect to the “period of planting a sweet potato” among the items for each topic, and a bar graph is increased to 6.

The measurement module 230 may confirm the knowledge gap which is a portion in which there no bar graph, and for example, inform the member in the knowledge group of a fact that there is the knowledge gap regarding whether to seed a carrot or to plant a seed.

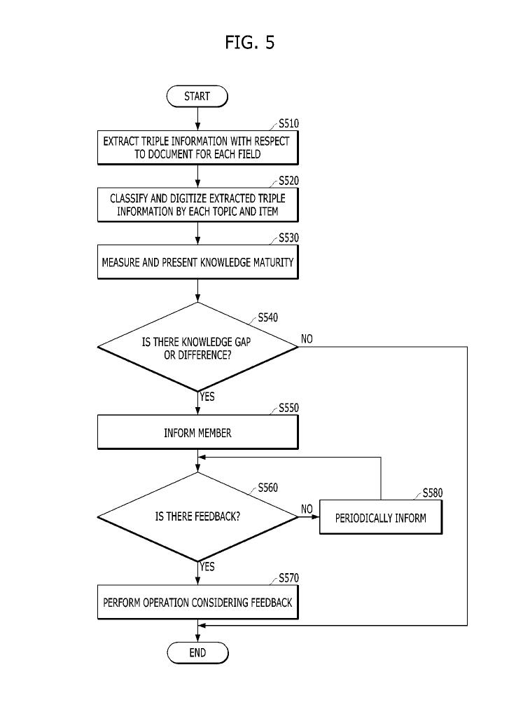

FIG. 5 is a flowchart for describing a knowledge evaluation method according to an embodiment of the present invention.

First, the knowledge evaluation apparatus 200 may extract the triple information with respect to the document for each field accumulated in the knowledge group (S510).

Here, the triple information may be the most general information extraction form, and express the knowledge information in a sentence as a relation of subject, predicate, and object. For example, the triple information may be the subject:a subject form, the predicate, the object:an object form, and the subject form and the object form may be an entity name form of the subject and the object. For example, when the entity name is Hong Gil Dong, the entity name form may be a person's name, and when the entity name is a worker, the entity name form may be a job.

In this case, the knowledge evaluation apparatus 200 may classify the document in the knowledge group by each field using a field set by a manager (or an operator, etc.) in the knowledge group, confirm the document accumulated in each field, and extract the triple information by analyzing the sentence in each document. For example, there may be fields such as seeding, harvesting, pest control, fertilizing, etc. in the knowledge group related to a vegetable garden.

As one example, the knowledge evaluation apparatus 200 may extract the triple information with respect to the document for each field by a previously set period (for example, one week). As another example, the extraction module 210 may extract the triple information whenever the document for each field is updated.

The knowledge evaluation apparatus 200 may classify and digitize the extracted triple information by the topic and item (S520).

The knowledge evaluation apparatus 200 may classify the triple information extracted in the operation S510 by each topic corresponding to a first entity name which is previously set, and classify the triple information classified by each topic by a sub-item which is previously set.

For example, when the knowledge group is a community formed by people having an interest in an organic food, the fields of a corresponding community may be harvesting, pest control, cooking, etc. In this case, each vegetable name which is the first entity name of the “harvesting” field is the topic of each field, and its sub-items may be a seeding period (when), a seeding place (where), a seeding transplantation (what), a seeding method (how), or a hobby (why), etc.

The knowledge evaluation apparatus 200 may classify every first entity name confirmed from the extracted triple information as a different topic, respectively.

The knowledge evaluation apparatus 200 may measure the knowledge maturity of each field of the knowledge group based on the digitized knowledge, and present the measured knowledge maturity to the member and the portal site (S530).

The knowledge evaluation apparatus 200 may perform at least one among a knowledge maturity measurement, a knowledge gap presentation, and a knowledge difference portion presentation based on the knowledge classified in the operation S520.

First, when describing the knowledge maturity measurement, the knowledge evaluation apparatus 200 may calculate a degree in which an item for each topic of knowledge which is classified is filled as a percentage, and measure the knowledge maturity of a corresponding knowledge group by calculating an average or an average of weight values of the calculated percentages. In this case, when there is at least one sub-item in each topic, the corresponding item may be evaluated to be filled. Further, when every sub-item of each topic is filled, the measurement module 230 may confirm that the corresponding topic is completed.

For example, when the “harvesting” field in the knowledge group having an interest in the “organic food” is filled by 90%, the “pest control” field is filled by 50%, and the “cooking” field is filled by 10%, the knowledge maturity of the corresponding knowledge group may be

$$50 ( = \frac{90 + 50 + 10}{3} )$$

points which are an average of each field. Alternatively, when weight values of the “harvesting,” “pest control,” and “cooking” fields in the corresponding knowledge group are 0.6, 0.3, and 0.1, respectively, the knowledge maturity of the corresponding knowledge group may be 70 (=0.6×90+0.3×50+0.1×10) points which are an average of the weight values of each field.

The knowledge evaluation apparatus 200 may present the measured knowledge maturity as described above to at least one of the Internet community and the portal site. Accordingly, an embodiment of the present invention may provide a basis capable of allowing the members inside or outside the knowledge group in each portal site to determine the knowledge maturity between knowledge groups more objectively.

Further, the knowledge evaluation apparatus 200 may confirm whether there is the knowledge gap or the knowledge difference (S540), and when there is the knowledge gap or the knowledge difference, inform the member (S550).

Here, the knowledge evaluation apparatus 200 may inform every member in the knowledge group of the knowledge gap or the knowledge difference, and inform some of the members such as an operator, etc. of the knowledge gap or the knowledge difference.

In this case, the member in the knowledge group confirming the knowledge gap may upload the document for filling the knowledge gap in order to compensate information needed in the knowledge group. Accordingly, the knowledge maturity of the knowledge group to which he/she belongs may be improved.

Further, the member in the knowledge group confirming the knowledge difference may confirm whether the knowledge difference corresponds to an error or content in which a subdivision is needed, and request an error correction or a subdivision.

Accordingly, the knowledge evaluation apparatus 200 may confirm whether there is a feedback of the member with respect to the knowledge gap or the knowledge difference (S560), and when there is the feedback, perform an operation corresponding to the feedback (S570).

In detail, the knowledge evaluation apparatus 200 may perform the triple information extraction, classification and digitization, the knowledge maturity update, etc. with respect to the corresponding document when updating the document with respect to the knowledge gap. Alternatively, the knowledge evaluation apparatus 200 may delete the document corresponding to the knowledge difference when the knowledge difference is an error, and subdivide the item of the triple information corresponding to the knowledge difference when the knowledge difference is content which is to be subdivided.

As one example, when a total of three triple information is extracted with respect to a “period of planting codonopsis lanceolata” and the periods are “early April,” “Autumn,” and “early November” respectively, the knowledge evaluation apparatus 200 may determine that there is the knowledge difference in the corresponding triple information, inform the member in the knowledge group, and request a solution. After this, when an answer indicating that one of three pieces of the triple information is incorrect is received from at least one member, the knowledge evaluation apparatus 200 may remove the knowledge difference by deleting the incorrect triple information and the document from which the incorrect triple information is extracted.

As another example, when different triple information is extracted with respect to a “period of planting a potato” and the periods are “late March,” and “late May” respectively, the knowledge evaluation apparatus 200 may inform the member in the knowledge group of the knowledge difference. After this, the knowledge evaluation apparatus 200 may receive a feedback in which the planting is performed “in Chungcheong in late March” and the planting is performed “in Hongcheon in late May” from the member. In this case, the knowledge evaluation apparatus 200 may perform the knowledge subdivision of subdividing the item “where” of the topic “potato”.

The knowledge evaluation apparatus 200 described above may receive answers of a plurality of members in order to increase accuracy of the solution with respect to the knowledge difference, and remove the knowledge difference.

On the other hand, when there is not a feedback with respect to the knowledge gap or the knowledge difference as a result confirmed in the operation S560, the knowledge evaluation apparatus 200 may periodically inform the knowledge group (S580).

An embodiment of the present invention may refer to the triple information with respect to the document for a portion or all of fields in the knowledge group, and measure the knowledge maturity in an objective manner compared with the conventional art.

Further, an embodiment of the present invention may present whether it is good to compensate the knowledge of any portion in order to increase the knowledge maturity of the knowledge group, allow the member to correct an error or subdivide the item by informing the member of the knowledge difference, and improve the knowledge maturity and the reliability in the knowledge group.

Moreover, an embodiment of the present invention may motivate the knowledge group to increase the knowledge maturities of various Internet communities and induce active knowledge accumulation activities in the knowledge group by disclosing the knowledge maturity with respect to various knowledge groups in the portal site, and provide a driving force for securing competitiveness of a search market and an advertising market to each portal operator.

It will be apparent to those skilled in the art that various modifications can be made to the above-described exemplary embodiments of the present invention without departing from the spirit or scope of the invention. Accordingly, the exemplary embodiments of the present invention is for the purpose of describing particular embodiments only and is not intended to be limiting of the invention, and the scope of the present invention is not limited by the exemplary embodiments of the present invention. The scope of the present invention should be defined by the claims, and it is intended that the present invention covers all such modifications provided they come within the scope of the appended claims and their equivalents.

What is claimed is:

1. A knowledge evaluation apparatus, comprising:
an extraction module configured to extract at least one of triple information which is previously set with respect to a document for each field accumulated in an Internet community site;
a classification module configured to classify and digitize the triple information extracted from the document for each field by a topic and an item; and
a measurement module configured to measure knowledge maturity of the Internet community site based on the knowledge classified and digitized by the classification module.

2. The knowledge evaluation apparatus of claim 1, wherein the extraction module classifies the document for each field based on the field which is previously set by a manager in the Internet community site, and extracts the triple information with respect to the document for each field.

3. The knowledge evaluation apparatus of claim 1, wherein the classification module classifies the triple information by each topic according to a first entity name which is previously set, and classifies and digitizes the triple information classified by each topic by an item which is previously set.

4. The knowledge evaluation apparatus of claim 1, wherein the measurement module confirms whether there is a knowledge gap among each topic and items in each topic in the classified knowledge, and informs a member in the Internet community site.

5. The knowledge evaluation apparatus of claim 1, wherein the measurement module confirms a knowledge difference among items in each topic in the classified knowledge, and informs a member in the Internet community site.

6. The knowledge evaluation apparatus of claim 5, wherein, when it is confirmed that the knowledge difference is an error by a feedback of the member, the measurement module or another component deletes a document corresponding to the knowledge difference.

7. The knowledge evaluation apparatus of claim 5, wherein, when it is confirmed that the knowledge difference is content needed to be subdivided, the classification module subdivides the triple information corresponding to the knowledge difference into a plurality of topics or items.

8. The knowledge evaluation apparatus of claim 5, wherein the measurement module receives solutions from a plurality of members confirming the knowledge difference, and solves the knowledge difference.

9. The knowledge evaluation apparatus of claim 1, wherein the extraction module extracts the triple information with respect to the document for each field in each period which is previously set or when updating the document for each field.

10. A knowledge evaluation method, comprising:
extracting at least one of triple information which is previously set with respect to a document for each field accumulated in an Internet community site;
classifying and digitizing the triple information extracted from the document for each field by a topic and an item; and
measuring knowledge maturity of the Internet community site based on the knowledge classified and digitized in the classifying and digitizing of the triple information.

11. The knowledge evaluation method of claim 10, wherein the extracting of at least one of the triple information comprises:
classifying the document for each field based on the field which is previously set by a manager in the Internet community site; and
extracting the triple information with respect to the document for each field.

12. The knowledge evaluation method of claim 10, wherein the classifying and digitizing of the triple information comprises:
classifying the triple information by each topic according to a first entity name which is previously set; and
classifying and digitizing the triple information classified by each topic by an item which is previously set.

13. The knowledge evaluation method of claim 10, wherein the measuring of the knowledge maturity comprises:
confirming whether there is a knowledge gap among each topic and items in each topic in the classified knowledge, and informing a member in the Internet community site.

14. The knowledge evaluation method of claim 10, wherein the measuring of the knowledge maturity comprises:
confirming the knowledge difference among items in each topic in the classified knowledge, and informing a member in the Internet community site.

15. The knowledge evaluation method of claim 14, when it is confirmed that the knowledge difference is an error by a feedback of the member, further comprising:
after the measuring of the knowledge maturity, deleting a document corresponding to the knowledge difference.

16. The knowledge evaluation method of claim 14, when it is confirmed that the knowledge difference is content needed to be subdivided, further comprising:
after the measuring of the knowledge maturity, subdividing the triple information corresponding to the knowledge difference into a plurality of topics or items.

17. The knowledge evaluation method of claim 14, wherein the measuring of the knowledge maturity comprises:
receiving solutions from a plurality of members confirming the knowledge difference, and solving the knowledge difference.

18. The knowledge evaluation method of claim 10, wherein the extracting of the triple information extracts the triple information with respect to the document for each field each field by a previously set period.

19. A knowledge evaluation system, comprising:
a database configured to store a document for each field accumulated in an Internet community site; and
a knowledge evaluation apparatus configured to extract at least one of triple information which is previously set with respect to the document for each field, classify and digitize the triple information by a topic and an item, and measure knowledge maturity of the Internet community site.

20. The knowledge evaluation system of claim 19, wherein the knowledge evaluation apparatus extracts the triple information with respect to the document for each field in a period which is previously set or when updating the document for each field.
